(19) United States
(12) Patent Application Publication
(10) Pub. No.: US 2023/0054306 A1
(43) Pub. Date: Feb. 23, 2023

(54) COMMUNICATION SYSTEM, APPARATUS, METHOD FOR CONTROLLING APPARATUS, AND METHOD FOR MANUFACTURING MOBILE DEVICE

(71) Applicant: KABUSHIKI KAISHA TOKAI RIKA DENKI SEISAKUSHO, Aichi (JP)

(72) Inventors: Keita SOBUE, Aichi (JP); Yosuke OHASHI, Aichi (JP); Shingo MOCHIZUKI, Aichi (JP); Norihiro SHIMIZU, Aichi (JP)

(73) Assignee: KABUSHIKI KAISHA TOKAI RIKA DENKI SEISAKUSHO, Aichi (JP)

(21) Appl. No.: 17/797,258

(22) PCT Filed: Dec. 14, 2020
(86) PCT No.: PCT/JP2020/046491

§ 371 Date: Aug. 3, 2022

(30) Foreign Application Priority Data
Mar. 23, 2020 (JP) 2020-051353
Nov. 12, 2020 (JP) 2020-188475

(51) Int. Cl. H04L 9/08; H04W 12/04; H04W 12/06; H04L 9/32

(52) U.S. Cl. CPC H04L 9/0816; H04W 12/04; H04W 12/06; H04L 9/3234

(57) ABSTRACT

A communication system includes a mobile device and an apparatus. The apparatus obtains unique data from the mobile device by using a common key while the common key is stored in the mobile device, generates a unique key by using the obtained unique data, stores the generated unique key as a service key in the apparatus, and transmits the generated unique key to the mobile device. When the mobile device receives the unique key from the apparatus while the common key is stored in the mobile device, the mobile device rewrites a service key stored in the mobile device from the common key to the unique key.

### TECHNICAL FIELD

The present disclosure relates to a communication system, an apparatus used in the communication system and a method for controlling the apparatus, and a method for manufacturing a mobile device used in the communication system.

### BACKGROUND ART

There are known techniques for performing functions such as locking/unlocking of the doors of vehicles, houses or the like by using a mobile device such as a smartphone or a card having a communication function as an electronic key. Japanese Patent Laying-Open No. 2013-100645 (PTL 1), for example, discloses a communication system including a mobile device and an in-vehicle apparatus that are configured to perform bidirectional communication. In this communication system, wireless communication is performed between the mobile device and the in-vehicle apparatus using near field communication (for example, wireless communication using a communication method in conformity with the NFC (Near Field Communication) standards; hereinafter also referred to as “NFC communication”) and the like, and the mobile device is used as an electronic key to lock/unlock the doors of the vehicle or start the engine.

### CITATION LIST

### Patent Literature

PTL 1: Japanese Patent Laying-Open No. 2013-100645

### SUMMARY OF INVENTION

### Technical Problem

Some mobile devices store a communication key, and data that can be accessed from outside by using the communication key. In order for an external apparatus to access the data in such a mobile device, the same communication key as that stored in the mobile device also needs to be stored in the external apparatus.

Some conventional methods for allowing an external apparatus to communicate with a plurality of mobile devices store a common communication key in the external apparatus and the plurality of mobile devices.

In the conventional methods, however, since the common communication key is stored in the plurality of mobile devices, unauthorized leakage of the communication key from one mobile device will also allow access to the other mobile devices by using that communication key, which may compromise the confidentiality of data in the mobile devices.

To address this problem, if the communication key is individualized for each mobile device at the time of factory shipment (at the time of manufacture) of the mobile device, then the communication key individualized for each mobile device also needs to be stored in the apparatus at the time of factory shipment of the apparatus so as to allow the apparatus to access the data in the mobile device. This may result in reduced versatility of the mobile device and the apparatus.

The present disclosure has been made to solve the problem described above, and has an object to, in a communication system that performs communication between a mobile device and an apparatus, ensure the confidentiality of data in the mobile device while suppressing reduction in versatility of the mobile device and the apparatus.

### Solution to Problem

A communication system according to one aspect of the present disclosure includes: a mobile device that stores a communication key, and unique information that can be accessed from outside by using the communication key; and an apparatus that stores a common key as the communication key. The apparatus obtains the unique information from the mobile device by using the common key. The mobile device erases the communication key stored in the mobile device after starting to perform a process of transmitting the unique information to the apparatus.

According to the communication system described above, by storing the common key in the mobile device at the time of factory shipment, the apparatus can obtain the unique information from the mobile device by using the common key after the factory shipment. The unique information is information used for communication between the apparatus and the mobile device, which may be a unique key, or unique data used to generate the unique key. As a result, the communication key can be individualized after the factory shipment without the need to individualize it at the time of factory shipment, so that reduction in versatility of the mobile device and the apparatus can be suppressed. Moreover, the mobile device erases the communication key stored in the mobile device after starting to perform a process of transmitting the unique information to the apparatus. That is, the common key is erased from the mobile device. This prevents leakage of the common key after the communication key has been individualized. The confidentiality of data in the mobile device can thereby be ensured.

An apparatus according to one aspect of the present disclosure performs communication with a mobile device by using a communication key. The mobile device stores the communication key, and unique data that can be transmitted to outside by using the communication key. The apparatus includes a storage device that stores a common key as the communication key, and a control device that controls communication with the mobile device. The control device obtains the unique data from the mobile device by using the common key stored in the storage device while the common key is stored in the mobile device, generates a unique key by using the obtained unique data, stores the generated unique key as the communication key in the storage device, and transmits the generated unique key to the mobile device to rewrite the communication key stored in the mobile device from the common key to the unique key.

A method for controlling an apparatus according to one aspect of the present disclosure is a method for controlling an apparatus that performs communication with a mobile device by using a communication key. The mobile device stores the communication key, and unique data that can be transmitted to outside by using the communication key. The apparatus includes a storage device that stores a common key as the communication key, a communication device that performs communication with the mobile device, and a control device that controls the communication device. The control method includes: obtaining the unique data from the mobile device by using the common key stored in the storage device while the common key is stored in the mobile device; generating a unique key by using the obtained unique data; storing the generated unique key as the communication key in the storage device; and transmitting the generated unique key to the mobile device to rewrite the communication key stored in the mobile device from the common key to the unique key.

According to the apparatus and the method for controlling an apparatus described above, even if the common key is stored in the mobile device and the apparatus at the time of factory shipment, after the factory shipment, the apparatus can obtain the unique data from the mobile device by using the common key, generate the unique key by using that unique data, and store the generated unique key in both the mobile device and the apparatus. That is, the communication key can be individualized after the factory shipment without the need to individualize it at the time of factory shipment. This can suppress reduction in versatility of the mobile device and the apparatus. Moreover, when the mobile device receives the unique key from the apparatus, the communication key stored in the mobile device is rewritten from the common key to the unique key. That is, the common key is erased from the mobile device. This prevents leakage of the common key after the communication key has been individualized. The confidentiality of data in the mobile device can thereby be ensured.

A method for manufacturing a mobile device according to one aspect of the present disclosure is a method for manufacturing a mobile device that stores a communication key, and unique data that can be accessed from outside by using the communication key. This manufacturing method includes: while a first mobile device storing a common key as the communication key and an apparatus storing the common key as the communication key are connected for communication, transmitting the unique data from the first mobile device to the apparatus by using the common key; generating, in the apparatus, a unique key by using the unique data; transmitting the unique key generated in the apparatus from the apparatus to the first mobile device; and rewriting the communication key stored in the first mobile device from the common key to the unique key, to manufacture a second mobile device storing the unique key as the communication key.

According to the method for manufacturing a mobile device described above, the unique data can be transmitted from the first mobile device to the apparatus by using the common key, the unique key can be generated in the apparatus by using the unique data, and the communication key stored in the first mobile device can be rewritten from the common key to the unique key, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

A method for manufacturing a mobile device according to another aspect of the present disclosure is a method for manufacturing a mobile device that stores a communication key, and unique data that can be accessed from outside by using the communication key. This manufacturing method includes: while a first mobile device storing a common key as the communication key and an apparatus storing the common key as the communication key are connected for communication, transmitting the unique data from the first mobile device to the apparatus by using the common key; generating, in the apparatus, a unique key by using the unique data received from the first mobile device; generating, in the first mobile device, the unique key by using the unique data stored in the first mobile device; and rewriting the communication key stored in the first mobile device from the common key to the unique key, to manufacture a second mobile device storing the unique key as the communication key.

According to the method for manufacturing a mobile device described above, the unique data can be transmitted from the first mobile device to the apparatus by using the common key, the unique key can be generated in each of the apparatus and the first mobile device by using the unique data, and the communication key stored in the first mobile device can be rewritten from the common key to the unique key, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

A method for manufacturing a mobile device according to another aspect of the present disclosure is a method for manufacturing a mobile device that stores a communication key. This manufacturing method includes: writing a unique key in a first mobile device storing a common key as the communication key; while the first mobile device and an apparatus storing the common key as the communication key are connected for communication, transmitting the unique key from the first mobile device to the apparatus by using the common key; rewriting the communication key stored in the apparatus from the common key to the unique key; and rewriting the communication key stored in the first mobile device from the common key to the unique key, to manufacture a second mobile device storing the unique key as the communication key.

According to the another method for manufacturing a mobile device described above, the unique key is written in the first mobile device, the unique key is transmitted from the first mobile device to the apparatus by using the common key, and the communication key is rewritten from the common key to the unique key in the first mobile device and the apparatus, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

### Advantageous Effects of Invention

According to the present disclosure, in a communication system that performs communication between a mobile device and an apparatus, the confidentiality of data in the mobile device can be ensured while reduction in versatility of the mobile device and the apparatus is suppressed.

### BRIEF DESCRIPTION OF DRAWINGS

FIG. 1 is a diagram schematically showing an example configuration of a communication system.

FIG. 2 is a diagram schematically showing example configurations of a storage device of an apparatus and a storage device of a mobile device.

FIG. 3 is a diagram (No. 1) schematically showing steps of a process of rewriting a service key performed by the communication system.

FIG. 4 is a sequence diagram (No. 1) showing an example procedure for the process of rewriting the service key performed by the communication system.

FIG. 5 is a diagram (No. 2) schematically showing steps of a process of rewriting a service key performed by the communication system.

FIG. 6 is a sequence diagram (No. 2) showing an example procedure for the process of rewriting the service key performed by the communication system.

FIG. 7 is a diagram (No. 3) schematically showing steps of a process of rewriting a service key performed by the communication system.

FIG. 8 is a sequence diagram (No. 3) showing an example procedure for the process of rewriting the service key performed by the communication system.

### DESCRIPTION OF EMBODIMENTS

An embodiment of the present disclosure will be described in detail hereinafter with reference to the drawings, in which the same or corresponding portions are denoted by the same characters and description thereof will not be repeated.

FIG. 1 is a diagram schematically showing an example configuration of a communication system 1 according to the present embodiment. Communication system 1 according to the present embodiment includes an apparatus 100 and a mobile device 200.

Apparatus 100 is a device (so-called “reader/writer”) having the function of performing wireless communication with mobile device 200 to read data from or write data to mobile device 200. Apparatus 100 may also have the function of performing predetermined control. When apparatus 100 is mounted on a vehicle, for example, apparatus 100 may have the function of controlling locking/unlocking of the doors of the vehicle by using mobile device 200 as an electronic key.

Apparatus 100 includes a communication device 110, a storage device 120, a control device 130, and an input device 140. Communication device 110 is configured to perform wireless communication with mobile device 200. Storage device 120 stores information of a communication key (hereinafter also referred to as “service key”) used for wireless communication between apparatus 100 and mobile device 200, and the like.

Control device 130 is configured to include a CPU (Central Processing Unit) and input/output ports for inputting and outputting various signals (neither shown). Control device 130 controls communication device 110 to perform wireless communication with mobile device 200 by using the service key stored in storage device 120. Control device 130 may also be configured, for example, to perform predetermined control based on information obtained through the wireless communication with mobile device 200. The control performed by control device 130 is not limited to processing using software, and dedicated hardware (electronic circuitry) may also process the control.

Input device 140 is configured to accept user operations. Input device 140 outputs information of the inputted operation to control device 130. The information outputted from input device 140 to control device 130 is used for control by control device 130.

mobile device 200 includes a communication device 210, a storage device 220, and a control device 230. Communication device 210 is configured to perform wireless communication with apparatus 100. Storage device 220 stores information of the service key used for communication with mobile device 200, unique data that can be accessed from outside by using the service key, and the like.

mobile device 200 is configured to be carried by the user. When apparatus 100 is mounted on a vehicle, mobile device 200 may function as an electronic key to the vehicle. mobile device 200 is implemented, for example, as a card having NFC communication functions (NFC card). In this case, mobile device 200 and apparatus 100 are configured to perform NFC communication with each other. Of the NFC communication functions, at least a card emulation function is incorporated into mobile device 200. The card emulation function is a passive-type communication function. When mobile device 200 is located within an NFC communicable range (a narrow range of about several centimeters) of apparatus 100, mobile device 200 is activated with power received from an electric wave from apparatus 100, to output an electric wave including the information stored in storage device 220

mobile device 200 may be implemented as a smartphone or the like having the NFC communication functions or a communication function other than NFC (such as BLE (Bluetooth Low Energy)).

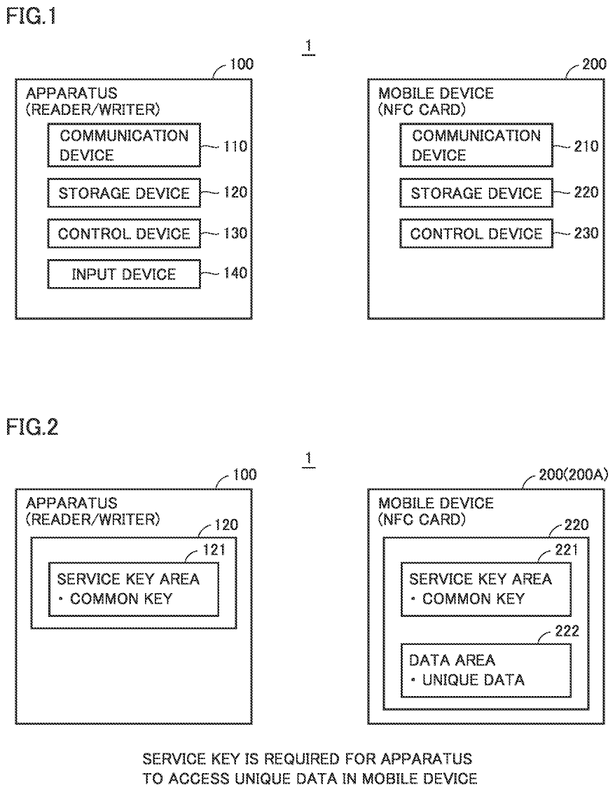

FIG. 2 is a diagram schematically showing example configurations of storage device 120 of apparatus 100 and storage device 220 of mobile device 200.

Storage device 120 of apparatus 100 includes a service key area 121 that stores the service key. Storage device 220 of mobile device 200 includes a service key area 221 that stores the service key, and a data area 222 that stores the unique data. The unique data is data that varies with each mobile device 200 (such as a unique code or a random number).

In order to access the unique data stored in data area 222 from outside, the same service key as that stored in service key area 221 is required. In order for apparatus 100 to access the unique data in mobile device 200, therefore, the same service key as that stored in service key area 221 of mobile device 200 needs to be stored in service key area 121 of apparatus 100.

FIG. 2 shows apparatus 100 and mobile device 200 in the factory-shipped state. As shown in FIG. 2, at the time of factory shipment, the same common key is stored in service key area 121 of apparatus 100 and service key area 221 of mobile device 200. That is, at the time of factory shipment, the service keys of apparatus 100 and mobile device 200 are not individualized, and the same common key is stored in them.

(Rewriting of Service Key)

As described above, at the time of factory shipment of apparatus 100 and mobile 200, the service keys of apparatus 100 and mobile device 200 are not individualized, and the same common key is stored in them. Therefore, even if a plurality of apparatuses 100 and a plurality of mobile devices 200 are manufactured, each apparatus 100 can access individual data in any mobile device 200 by using the common key.

In this situation, however, unauthorized leakage of the service key from one mobile device 200 will also allow access to individual data in the other mobile devices 200 by using that service key, which may compromise the confidentiality of data in mobile devices 200.

To address this problem, if the service key is individualized for each mobile device 200 at the time of factory shipment (at the time of manufacture) of mobile device 200, then the service key individualized for each mobile device 200 also needs to be stored in apparatus 100 at the time of factory shipment of apparatus 100 so as to allow apparatus 100 to access the data in mobile device 200. This may result in reduced versatility of mobile device 200 and apparatus 100.

In communication system 1 according to the present embodiment, therefore, a process of rewriting the service key is performed in a manner described below, to ensure the confidentiality of data in mobile device 200, while suppressing reduction in versatility of mobile device 200 and apparatus 100.

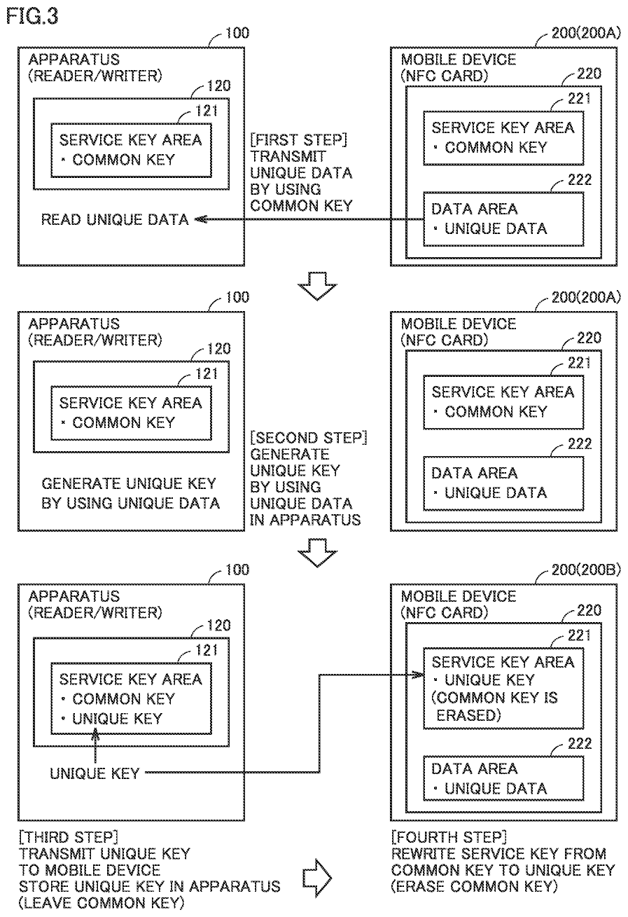

FIG. 3 is a diagram schematically showing steps of the process of rewriting the service key performed by communication system 1.

Initially, in the first step, a mobile device 200 (hereinafter also referred to as “first mobile device 200A”) and apparatus 100, each storing a common key as a service key, are prepared, and while first mobile device 200A and apparatus 100 prepared are connected for communication, unique data is transmitted from first mobile device 200A to apparatus 100 by using the common key. The common key is a common service key stored in all apparatuses 100 and all mobile devices 200 at the time of factory shipment.

Then, in the second step, in apparatus 100, a unique key is generated based on a predetermined algorithm by using the unique data obtained from first mobile device 200A. The unique key is a service key individualized for each first mobile device 200A.

Then, in the third step, in apparatus 100, the generated unique key is transmitted from apparatus 100 to first mobile device 200A. In the third step, the generated unique key is also stored in service key area 121 of apparatus 100. In this case, the common key originally stored in service key area 121 of apparatus 100 is left without being erased.

Then, in the fourth step, in mobile device 200, the service key stored in service key area 221 is rewritten from the common key to the unique key received from apparatus 100. As a result, first mobile device 200A storing the common key as the service key is used to manufacture a mobile device 200 storing the unique key as the service key (hereinafter also referred to as “second mobile device 200B”). The common key is erased from second mobile device 200B.

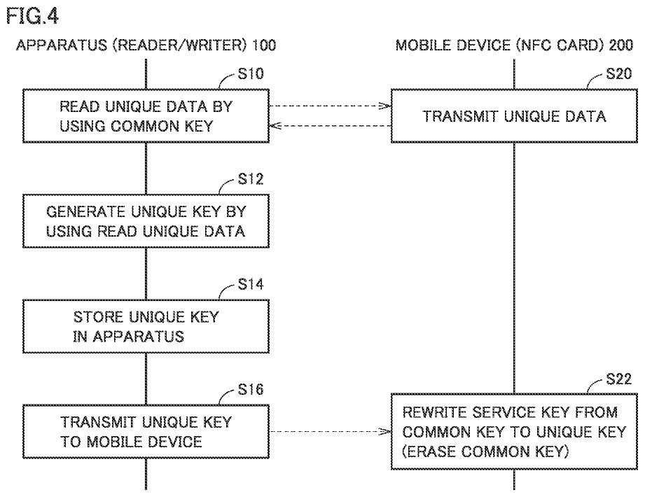

FIG. 4 is a sequence diagram showing an example procedure for the process of rewriting the service key performed by communication system 1.

While apparatus 100 is connected for communication to mobile device 200 (first mobile device 200A) storing the common key as the service key, apparatus 100 reads the unique data from mobile device 200 by using the common key (step S10). Specifically, apparatus 100 transmits the common key to mobile device 200 (first mobile device 200A) to request transmission of the unique data. In response to the request from apparatus 100, mobile device 200 (first mobile device 200A) transmits the unique data to apparatus 100 (step S20).

Then, apparatus 100 generates the unique key based on a predetermined algorithm by using the unique data read from mobile device 200 (step S12). Then, apparatus 100 stores the generated unique key in service key area 121 within apparatus 100 (step S14), and transmits the generated unique key to mobile device 200 (first mobile device 200A) (step S16).

Thereafter, upon receiving the unique key from apparatus 100, mobile device 200 rewrites the service key stored in service key area 221 from the common key to the unique key received from apparatus 100 (step S22). In this case, the common key stored in service key area 221 is erased.

As described above, communication system 1 according to the present embodiment includes: mobile device 200 that stores the service key, and the unique data that can be accessed from outside by using the service key; and apparatus 100 that stores the common key as the service key. Apparatus 100 obtains the unique data from mobile device 200 by using the common key while the common key is stored in mobile device 200, generates the unique key by using the obtained unique data, stores the generated unique key as the service key in apparatus 100, and transmits the generated unique key to mobile device 200. When mobile device 200 receives the unique key from apparatus 100 while the common key is stored in mobile device 200, mobile device 200 rewrites the service key stored in mobile device 200 from the common key to the unique key.

According to communication system 1 described above, even if the common key is stored in mobile device 200 and apparatus 100 at the time of factory shipment, after the factory shipment, apparatus 100 can obtain the unique data from mobile device 200 by using the common key, generate the unique key by using that unique data, and store the generated unique key in both mobile device 200 and apparatus 100.

That is, the service key can be individualized after the factory shipment (for example, when mobile device 200 is registered with apparatus 100) without the need to individualize it at the time of factory shipment. This can suppress reduction in versatility of mobile device 200 and apparatus 100 as compared to their versatility at the time of factory shipment. Moreover, when mobile device 200 receives the unique key from apparatus 100, the service key stored in mobile device 200 is rewritten from the common key to the unique key. That is, the common key is erased from mobile device 200. This prevents leakage of the common key from the mobile device after the service key has been individualized. The confidentiality of data in mobile device 200 can thereby be ensured. As a result, the confidentiality of data in mobile device 200 can be ensured, while reduction in versatility of mobile device 200 and apparatus 100 is suppressed.

Moreover, in communication system 1 according to the present embodiment, apparatus 100 leaves the common key when storing the generated unique key in apparatus 100. Apparatus 100 can thereby perform the process of rewriting the service key on a plurality of mobile devices 200. Thus, the versatility of apparatus 100 after the factory shipment can also be ensured.

[First Modification]

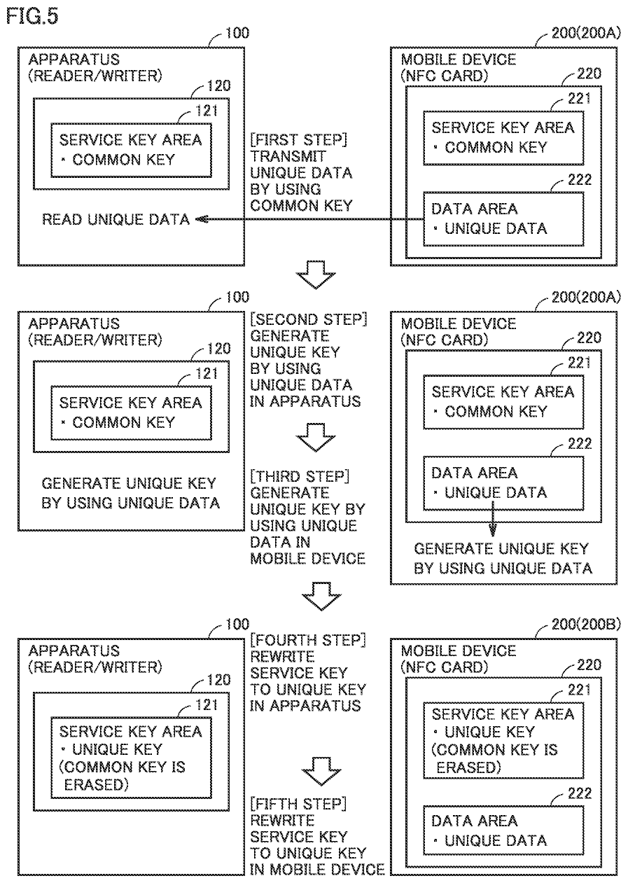

FIG. 5 is a diagram schematically showing steps of a process of rewriting a service key performed by communication system 1 according to the present first modification.

The first step is the same as that of the embodiment described above. That is, initially, in the first step, while mobile device 200 (first mobile device 200A) and apparatus 100, each storing a common key as a service key, are connected for communication, unique data is transmitted from first mobile device 200A to apparatus 100 by using the common key.

The second step is also the same as that of the embodiment described above. That is, in the second step, in apparatus 100, a unique key is generated based on a predetermined algorithm by using the unique data obtained from first mobile device 200A.

Then, in the third step, in first mobile device 200A, the unique key is generated based on a predetermined algorithm by using the unique data stored in data area 222.

Then, in the fourth step, in apparatus 100, the service key stored in service key area 121 is rewritten from the common key to the unique key generated in the second step. As a result, the common key is erased from apparatus 100.

Then, in the fifth step, in mobile device 200, the service key stored in service key area 221 is rewritten from the common key to the unique key generated in the third step. As a result, first mobile device 200A storing the common key as the service key is used to manufacture second mobile device 200B storing the unique key as the service key.

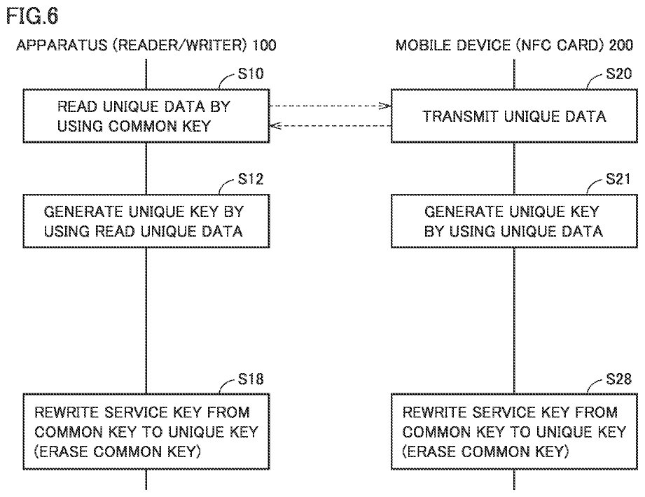

FIG. 6 is a sequence diagram showing an example procedure for the process of rewriting the service key performed by communication system 1 according to the present first modification. Of the steps shown in FIG. 6, those denoted by the same numbers as the steps shown in FIG. 4 described above have already been described, and thus detailed description thereof will not be repeated.

While apparatus 100 is connected for communication to mobile device 200 (first mobile device 200A) storing the common key as the service key, apparatus 100 reads the unique data from mobile device 200 by using the common key (step S10).

Then, apparatus 100 generates the unique key based on a predetermined algorithm by using the unique data read from mobile device 200 (step S12).

Then, apparatus 100 rewrites the service key stored in service key area 121 from the common key to the unique key (step S18). As a result, the common key is erased from apparatus 100.

On the other hand, after transmitting the unique data to mobile device 200 in step S20, mobile device 200 generates the unique key based on a predetermined algorithm by using the unique data stored in data area 222 (step S21).

Then, mobile device 200 rewrites the service key stored in service key area 221 from the common key to the unique key (step S28). As a result, second mobile device 200B storing the unique key as the service key is manufactured. The common key is erased from second mobile device 200B.

As described above, according to communication system 1 in the present first modification, even if the common key is stored in mobile device 200 and apparatus 100 at the time of factory shipment, after the factory shipment, apparatus 100 can obtain the unique data from mobile device 200 by using the common key, generate the unique key by using that unique data, and store the generated unique key. In addition, mobile device 200 can generate the unique key by using the unique data stored in itself, and store the generated unique key. That is, as in the embodiment described above, the service key can be individualized after the factory shipment (for example, when mobile device 200 is registered with apparatus 100) without the need to individualize it at the time of factory shipment. This can suppress reduction in versatility of mobile device 200 and apparatus 100 as compared to their versatility at the time of factory shipment. Moreover, the common key is erased from mobile device 200. This prevents leakage of the common key from mobile device 200 after the service key has been individualized. The confidentiality of data in mobile device 200 can thereby be ensured. As a result, the confidentiality of data in mobile device 200 can be ensured, while reduction in versatility of mobile device 200 and apparatus 100 is suppressed.

Moreover, apparatus 100 according to the present first modification erases the common key when storing the unique key. mobile device 200 according to the present first modification also erases the common key when storing the unique key. As a result, the confidentiality of data in mobile device 200 can be more appropriately ensured.

[Second Modification]

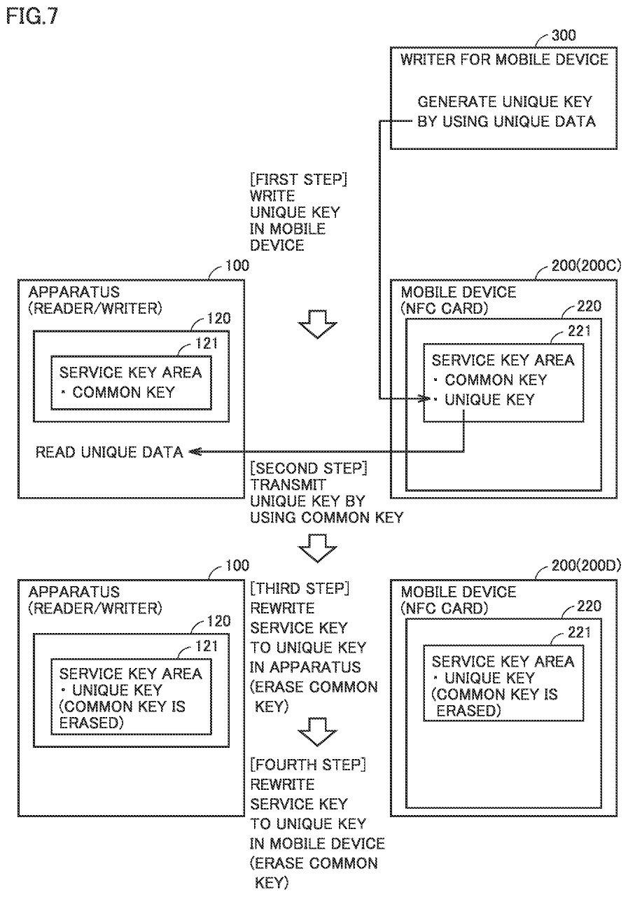

FIG. 7 is a diagram schematically showing steps of a process of rewriting a service key performed by communication system 1 according to the present second modification.

In the present second modification, a writer 300 capable of writing data in mobile device 200 is provided separately from apparatus 100. This writer 300 prestores unique data, and is configured to generate a unique key based on a predetermined algorithm by using the unique data.

In the present second modification, initially, in the first step, the unique key generated by writer 300 is written in service key area 221 of a mobile device 200 storing a common key stored as a service key and not having unique data (hereinafter also referred to as “first mobile device 200C”). At this time, service key area 221 of first mobile device 200C stores the originally stored common key, and the newly written unique key.

Then, in the second step, while first mobile device 200C and apparatus 100 are connected for communication, the unique key is transmitted from first mobile device 200C to apparatus 100 by using the common key.

Then, in the third step, in apparatus 100, the service key stored in service key area 121 is rewritten from the common key to the unique key received from first mobile device 200C. As a result, the common key is erased from apparatus 100.

Then, in the fourth step, in mobile device 200, of the common key and the unique key stored in service key area 221, the common key is erased while the unique key is left. As a result, first mobile device 200C storing the common key as the service key is used to manufacture a mobile device 200 storing the unique key as the service key (hereinafter also referred to as “second mobile device 200D”).

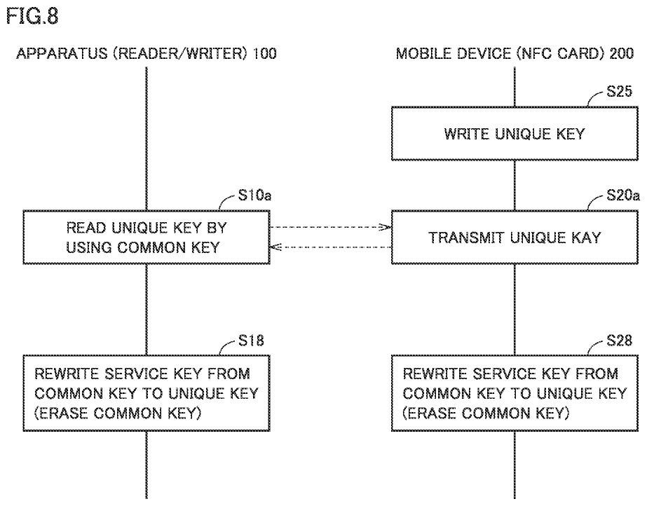

FIG. 8 is a sequence diagram showing an example procedure for the process of rewriting the service key performed by communication system 1 according to the present second modification.

mobile device 200 (first mobile device 200C) obtains the unique key generated by writer 300 from writer 300, and writes it in service key area 221 (step S25).

Then, while apparatus 100 is connected for communication to mobile device 200 (first mobile device 200C), apparatus 100 reads the unique key from mobile device 200 by using the common key (step S10a). Specifically, apparatus 100 transmits the common key to mobile device 200 (first mobile device 200C) to request transmission of the unique key. In response to the request from apparatus 100, mobile device 200 (first mobile device 200C) transmits the unique key to apparatus 100 (step S20a).

Then, apparatus 100 rewrites the service key stored in service key area 121 from the common key to the unique key (step S18). As a result, the common key is erased from apparatus 100.

On the other hand, after transmitting the unique key to mobile device 200 in step S20a, mobile device 200 rewrites the service key stored in service key area 221 from the common key to the unique key (step S28). As a result, first mobile device 200C storing the common key as the service key is used to manufacture second mobile device 200D storing the unique key as the service key.

As described above, according to communication system 1 in the present second modification, even if the common key is stored in mobile device 200 and apparatus 100 at the time of factory shipment, after the factory shipment, mobile device 200 can obtain the unique key from writer 300 and store the unique key, and apparatus 100 can obtain the unique key from mobile device 200 by using the common key and store the unique key. That is, as in the embodiment described above, the service key can be individualized after the factory shipment without the need to individualize it at the time of factory shipment. This can suppress reduction in versatility of mobile device 200 and apparatus 100 as compared to their versatility at the time of factory shipment. Moreover, the common key is erased from mobile device 200. This prevents leakage of the common key from mobile device 200 after the service key has been individualized. The confidentiality of data in mobile device 200 can thereby be ensured. As a result, the confidentiality of data in mobile device 200 can be ensured, while reduction in versatility of mobile device 200 and apparatus 100 is suppressed.

Moreover, apparatus 100 according to the present second modification erases the common key when storing the unique key. mobile device 200 according to the present second modification also erases the common key when storing the unique key. As a result, the confidentiality of data in mobile device 200 can be more appropriately ensured.

It should be understood that the embodiment disclosed herein is illustrative and non-restrictive in every respect. The scope of the present disclosure is defined by the scope of the claims, rather than the description above, and is intended to include any modifications within the scope and meaning equivalent to the scope of the claims.

The illustrative embodiment and its modifications described above are specific examples of aspects described below.

(1) A communication system according to one aspect of the present disclosure includes: a mobile device that stores a communication key, and unique information that can be accessed from outside by using the communication key; and an apparatus that stores a common key as the communication key. The apparatus obtains the unique information from the mobile device by using the common key. The mobile device erases the communication key stored in the mobile device after starting to perform a process of transmitting the unique information to the apparatus.

According to the aspect described above, by storing the common key in the mobile device at the time of factory shipment, the apparatus can obtain the unique information from the mobile device by using the common key after the factory shipment. The unique information is information used for communication between the apparatus and the mobile device, which may be a unique key, or unique data used to generate the unique key. As a result, the communication key can be individualized after the factory shipment without the need to individualize it at the time of factory shipment, so that reduction in versatility of the mobile device and the apparatus can be suppressed. Moreover, the mobile device erases the communication key stored in the mobile device after starting to perform a process of transmitting the unique information to the apparatus. That is, the common key is erased from the mobile device. This prevents leakage of the common key after the communication key has been individualized. The confidentiality of data in the mobile device can thereby be ensured.

(2) In one aspect, communication between the apparatus and the mobile device is performed when authentication based on the unique information is established.

(3) In one aspect, the unique information includes unique data used to generate a unique key. The apparatus generates the unique key based on the unique data, and transmits the generated unique key to the mobile device.

(4) In one aspect, the apparatus stores the unique key in the apparatus while leaving the common key in the apparatus.

According to the aspect described above, the apparatus stores the unique key in the apparatus while leaving the common key in the apparatus. The apparatus can thereby perform a process of rewriting the unique key on a plurality of mobile devices. Thus, the versatility of the apparatus after the factory shipment can also be ensured.

(5) In one aspect, the unique information is unique data used to generate a unique key. The apparatus generates the unique key based on the unique data obtained from the mobile device. The mobile device generates the unique key based on the unique data stored in the mobile device.

As in the aspect described above, the apparatus and the mobile device may each generate the unique key.

(6) In one aspect, the unique information is a unique key. The mobile device obtains the unique key from a writer different from the apparatus and stores the unique key. The apparatus obtains the unique key from the mobile device by using the common key.

As in the aspect described above, the unique key generated by the writer may be stored in the mobile device.

(7) In one aspect, the apparatus rewrites the communication key stored in the apparatus from the common key to the unique key.

According to the aspect described above, the confidentiality of data in the mobile device can be more appropriately ensured.

(8) In one aspect, the mobile device is activated with power received from an electric wave from the apparatus, to perform near field communication with the apparatus.

According to the aspect described above, the mobile device can be implemented as an NFC card.

(9) An apparatus according to one aspect of the present disclosure performs communication with a mobile device by using a communication key. The mobile device stores the communication key, and unique data that can be transmitted to outside by using the communication key. The apparatus includes a storage device that stores a common key as the communication key, and a control device that controls communication with the mobile device. The control device obtains the unique data from the mobile device by using the common key stored in the storage device while the common key is stored in the mobile device, generates a unique key by using the obtained unique data, stores the generated unique key as the communication key in the storage device, and transmits the generated unique key to the mobile device to rewrite the communication key stored in the mobile device from the common key to the unique key.

(10) A method for controlling an apparatus according to one aspect of the present disclosure is a method for controlling an apparatus that performs communication with a mobile device by using a communication key. The mobile device stores the communication key, and unique data that can be transmitted to outside by using the communication key. The apparatus includes a storage device that stores a common key as the communication key, a communication device that performs communication with the mobile device, and a control device that controls the communication device. The control method includes: obtaining the unique data from the mobile device by using the common key stored in the storage device while the common key is stored in the mobile device; generating a unique key by using the obtained unique data; storing the generated unique key as the communication key in the storage device; and transmitting the generated unique key to the mobile device to rewrite the communication key stored in the mobile device from the common key to the unique key.

According to the apparatus of (9) and the method for controlling an apparatus of (10) described above, even if the common key is stored in the mobile device and the apparatus at the time of factory shipment, after the factory shipment, the apparatus can obtain the unique data from the mobile device by using the common key, generate the unique key by using that unique data, and store the generated unique key in both the mobile device and the apparatus. That is, the communication key can be individualized after the factory shipment without the need to individualize it at the time of factory shipment. This can suppress reduction in versatility of the mobile device and the apparatus. Moreover, when the mobile device receives the unique key from the apparatus, the communication key stored in the mobile device is rewritten from the common key to the unique key. That is, the common key is erased from the mobile device. This prevents leakage of the common key after the communication key has been individualized. The confidentiality of data in the mobile device can thereby be ensured.

(11) A method for manufacturing a mobile device according to one aspect of the present disclosure is a method for manufacturing a mobile device that stores a communication key, and unique data that can be accessed from outside by using the communication key. This manufacturing method includes: while a first mobile device storing a common key as the communication key and an apparatus storing the common key as the communication key are connected for communication, transmitting the unique data from the first mobile device to the apparatus by using the common key; generating, in the apparatus, a unique key by using the unique data; transmitting the unique key generated in the apparatus from the apparatus to the first mobile device; and rewriting the communication key stored in the first mobile device from the common key to the unique key, to manufacture a second mobile device storing the unique key as the communication key.

According to the method for manufacturing a mobile device described above, the unique data can be transmitted from the first mobile device to the apparatus by using the common key, the unique key can be generated in the apparatus by using the unique data, and the communication key stored in the first mobile device can be rewritten from the common key to the unique key, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

(12) A method for manufacturing a mobile device according to another aspect of the present disclosure is a method for manufacturing a mobile device that stores a communication key, and unique data that can be accessed from outside by using the communication key. This manufacturing method includes: while a first mobile device storing a common key as the communication key and an apparatus storing the common key as the communication key are connected for communication, transmitting the unique data from the first mobile device to the apparatus by using the common key;

generating, in the apparatus, a unique key by using the unique data received from the first mobile device; generating, in the first mobile device, the unique key by using the unique data stored in the first mobile device; and rewriting the communication key stored in the first mobile device from the common key to the unique key, to manufacture a second mobile device storing the unique key as the communication key.

According to the method for manufacturing a mobile device described above, the unique data can be transmitted from the first mobile device to the apparatus by using the common key, the unique key can be generated in each of the apparatus and the first mobile device by using the unique data, and the communication key stored in the first mobile device can be rewritten from the common key to the unique key, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

(13) A method for manufacturing a mobile device according to another aspect of the present disclosure is a method for manufacturing a mobile device that stores a communication key. This manufacturing method includes: writing a unique key in a first mobile device storing a common key as the communication key; while the first mobile device and an apparatus storing the common key as the communication key are connected for communication, transmitting the unique key from the first mobile device to the apparatus by using the common key; rewriting the communication key stored in the apparatus from the common key to the unique key; and rewriting the communication key stored in the first mobile device from the common key to the unique key, to manufacture a second mobile device storing the unique key as the communication key.

According to the method for manufacturing a mobile device described above, the unique key is written in the first mobile device, the unique key is transmitted from the first mobile device to the apparatus by using the common key, and the communication key is rewritten from the common key to the unique key in the first mobile device and the apparatus, to manufacture the second mobile device storing the unique key. As a result, even if the first mobile device having a communication key that has not been individualized is shipped from the factory, after the factory shipment, the first mobile device can be used to readily manufacture the second mobile device having an individualized communication key. This can suppress reduction in versatility of the mobile device and the apparatus. Moreover, the common key is erased from the second mobile device. This prevents leakage of the common key from the second mobile device after the communication key has been individualized. The confidentiality of data in the mobile device can thereby be ensured.

### REFERENCE SIGNS LIST

1 communication system; 100 apparatus; 110, 210 communication device; 120, 220 storage device; 121, 221 service key area; 130, 230 control device; 140 input device; 200 mobile device; 200A, 200C first mobile device; 200B, 200D second mobile device; 222 data area; 300 writer.

1. A communication system comprising:
a mobile device that stores a communication key, and unique information that can be accessed from outside by using the communication key; and
an apparatus that stores a common key as the communication key, wherein
the apparatus obtains the unique information from the mobile device by using the common key, and
the mobile device erases the communication key stored in the mobile device after starting to perform a process of transmitting the unique information to the apparatus.

2. The communication system according to claim 1, wherein communication between the apparatus and the mobile device is performed when authentication based on the unique information is established.

3. The communication system according to claim 2, wherein
the unique information includes unique data used to generate a unique key, and
the apparatus generates the unique key based on the unique data, and transmits the generated unique key to the mobile device.

4. The communication system according to claim 3, wherein
the apparatus stores the unique key in the apparatus while leaving the common key in the apparatus.

5. The communication system according to claim 2, wherein
the unique information is unique data used to generate a unique key,
the apparatus generates the unique key based on the unique data obtained from the mobile device, and
the mobile device generates the unique key based on the unique data stored in the mobile device.

6. The communication system according to claim 2, wherein
the unique information is a unique key,
the mobile device obtains the unique key from a writer different from the apparatus and stores the unique key, and
the apparatus obtains the unique key from the mobile device by using the common key.

7. The communication system according to claim 5, wherein
the apparatus rewrites the communication key stored in the apparatus from the common key to the unique key.

8. The communication system according to claim 1, wherein
the mobile device is activated with power received from an electric wave from the apparatus, to perform near field communication with the apparatus.

9. An apparatus that performs communication with a mobile device by using a communication key,
the mobile device storing the communication key, and unique data that can be transmitted to outside by using the communication key,
the apparatus comprising:
a storage device that stores a common key as the communication key; and
a control device that controls communication with the mobile device, wherein the control device
obtains the unique data from the mobile device by using the common key stored in the storage device while the common key is stored in the mobile device,
generates a unique key by using the obtained unique data,
stores the generated unique key as the communication key in the storage device, and
transmits the generated unique key to the mobile device to rewrite the communication key stored in the mobile device from the common key to the unique key.

10. A method for controlling an apparatus that performs communication with a mobile device by using a communication key,
the mobile device storing the communication key, and unique data that can be transmitted to outside by using the communication key,
the apparatus including
a storage device that stores a common key as the communication key,
a communication device that performs communication with the mobile device, and
a control device that controls the communication device, and
the method comprising:
obtaining the unique data from the mobile device by using the common key stored in the storage device while the common key is stored in the mobile device;
generating a unique key by using the obtained unique data;
storing the generated unique key as the communication key in the storage device; and
transmitting the generated unique key to the mobile device to rewrite the communication key stored in the mobile device from the common key to the unique key.

11. A method for manufacturing a mobile device that stores a communication key, and unique data that can be accessed from outside by using the communication key, the method comprising:
while a first mobile device storing a common key as the communication key and an apparatus storing the common key as the communication key are connected for communication, transmitting the unique data from the first mobile device to the apparatus by using the common key;
generating, in the apparatus, a unique key by using the unique data;
transmitting the unique key generated in the apparatus from the apparatus to the first mobile device; and
rewriting the communication key stored in the first mobile device from the common key to the unique key, to manufacture a second mobile device storing the unique key as the communication key.

12. A method for manufacturing a mobile device that stores a communication key, and unique data that can be accessed from outside by using the communication key, the method comprising:
while a first mobile device storing a common key as the communication key and an apparatus storing the common key as the communication key are connected for communication, transmitting the unique data from the first mobile device to the apparatus by using the common key;
generating, in the apparatus, a unique key by using the unique data received from the first mobile device;
generating, in the first mobile device, the unique key by using the unique data stored in the first mobile device; and
rewriting the communication key stored in the first mobile device from the common key to the unique key, to manufacture a second mobile device storing the unique key as the communication key.

13. A method for manufacturing a mobile device that stores a communication key, the method comprising:
writing a unique key in a first mobile device storing a common key as the communication key;
while the first mobile device and an apparatus storing the common key as the communication key are connected for communication, transmitting the unique key from the first mobile device to the apparatus by using the common key;
rewriting the communication key stored in the apparatus from the common key to the unique key; and
rewriting the communication key stored in the first mobile device from the common key to the unique key, to manufacture a second mobile device storing the unique key as the communication key.
